(19) United States
(12) Patent Application Publication
(10) Pub. No.: US 2021/0392600 A1
(43) Pub. Date: Dec. 16, 2021

(54) Method and apparatus for calibrating a clock

(71) Applicant: Intel IP Corporation, Santa Clara, CA (US)

(72) Inventors: Bernd SCHMANDT, Wuppertal (DE); Frank HUERTGEN, Krefeld (DE); Michael Mike MEIXNER, Munich (DE); Admir BURNIC, Duisburg (DE); Stefan MEYER, Hoechstadt (DE); Stefan MUELLER-WEINFURTNER, Nuernberg (DE); Bernd SCHALLER, Nuernberg (DE)

(21) Appl. No.: 16/650,896

(22) PCT Filed: Dec. 18, 2017
(86) PCT No.: PCT/US2017/066920

§ 371 Date: Mar. 26, 2020

(51) Int. Cl. H04W 56/00

(52) U.S. Cl. CPC H04W 56/0035; H04W 56/0015; H04W 56/0045

(57) ABSTRACT

Examples provide a method for clock calibration. A wireless communication device includes a first clock and a second clock. The first clock is turned off but the second clock runs during the inactive state of the wireless communication device. A frequency offset of the first clock is measured with respect to a reference frequency based on a signal received from a network. A virtual timer, which is a software-based timer is updated based on the frequency offset. A drift of the second clock is measured over a predetermined time interval based on the virtual timer. The virtual timer is restored based on the drift after wake-up from the inactive state. Alternatively, a clock frequency relation between the first clock and the second clock may be measured and a phase locked loop (PLL) may be controlled based on the measured clock frequency relation.

### FIELD

Examples disclosed herein relate to a wireless communication device, a method, and a computer program for a wireless communication device, and in particular, but not exclusively, to a concept and mechanism for calibrating a clock in a wireless communication device following an inactive state of the wireless communication device or powering up the wireless communication device.

### BACKGROUND

In order to save a battery power, a modem chip within a mobile communication device may periodically enter into an inactive state. This periodic transition typically involves a regular short active state followed by a long inactive state. For example, a mobile phone needs to listen to the network to check for incoming calls. For example, this may be done once per discontinuous reception (DRX) cycle (e.g. once per 1.28 sec or 2.56 sec). Typically, the mobile phone has no activities to perform during the inactive state of the DRX cycle. For saving power, most parts of the modem of the mobile communication device may be powered down during the long inactive states. On the other hand, precise knowledge of the time is needed in the active states, e.g. to check for the incoming calls exactly synchronously to the transmit activity of the network. Therefore, the modem chip cannot be powered down completely during the inactive states, but needs to maintain a time basis while being inactive.

For power saving and cost reasons, normally the oscillator which is kept alive in the inactive states has a low absolute accuracy. In addition, even if it may include a temperature compensation, a relative change of the drift over time (e.g. drift change<0.5 ppm/sec) has to be taken into account. After the inactivity state the modem needs to restore the accurate timing by compensating the inaccuracy introduced in the inactive period. For timing recovery, different techniques may be implemented. A recovery may be possible if the accumulated drift in the inactive phase is within a certain drift window, e.g. ±4 μsec. Therefore, it needs to reduce the accumulated drift as much as possible.

An additional challenge is caused by the fact that the mobile communication systems often work with a free running (i.e. uncompensated) oscillator even in the active phases. The reason is that the clock is often shared between different applications (e.g. Global Positioning System (GPS) and Third Generation (3G) wireless communication), and any compensation of the clock by one application would cause disturbances for other applications. On the other hand, introducing more than one reference oscillator is not preferable due to cost reasons. The free running hardware clock is not suitable as a timing reference for the drift measurement against the inaccurate inactive clock, so the inaccuracy of the inactive clock cannot be improved by the hardware drift measurement.

### BRIEF DESCRIPTION OF THE FIGURES

Some examples of circuits, apparatuses, methods and/or computer programs will be described in the following by way of example only, and with reference to the accompanying figures, in which:

FIG. 1 illustrates an example of a user equipment (UE) and a base station;

FIG. 2 illustrates a UE in accordance with one aspect;

FIG. 3 shows an example of measured timer offsets between a software-based virtual timer and a physical timer;

FIG. 4 shows an example of measuring a drift of the second clock based on the virtual timer;

FIG. 5 shows an example of timing recovery after the UE wakes up from the inactive state based on the drift measurement;

FIG. 6 shows an example of measuring a drift of the second clock over an integration interval including an inactive state of the UE;

FIG. 7 shows a wireless communication device configured to implement clock calibration in accordance with one example;

FIG. 8 shows an example procedure of clock calibration after waking up from an inactive state for receiving a paging message; and

FIG. 9 shows an example procedure of clock calibration after powering up the wireless communication device and for performing a cell search.

### DETAILED DESCRIPTION

Various examples will now be described more fully with reference to the accompanying drawings in which some examples are illustrated. In the figures, the thicknesses of lines, layers and/or regions may be exaggerated for clarity. Optional components in the Figs. are shown using broken or dashed lines. Similar reference signs reference similar components throughout the drawings.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than two elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

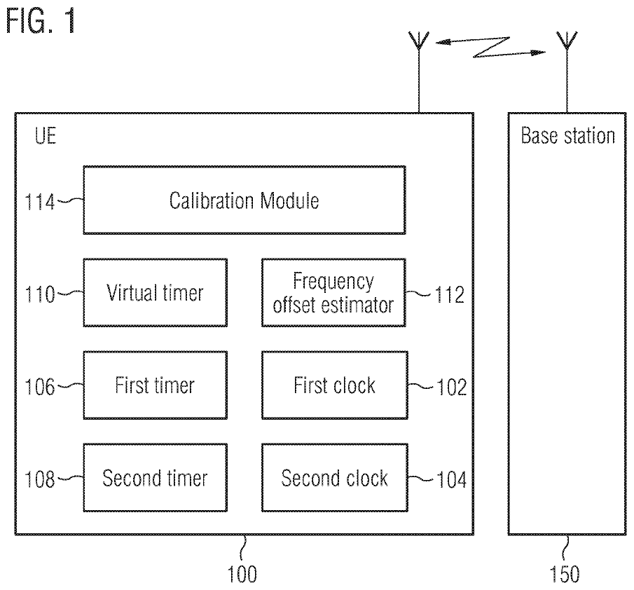

FIG. 1 illustrates an example of a UE 100 and a base station 150. The UE 100 is a wireless communication device including, but not limited to, a mobile terminal, a mobile transceiver, a smartphone, a cell phone, a station, a laptop, a notebook, a personal computer, a tablet computer, a Personal Digital Assistant (PDA), a Universal Serial Bus (USB) stick, or any other type of device having wireless transmission/reception capabilities. The UE 100 may have an active connection with the base station 150 or may be camping on a cell of the base station 150. The UE 100 may include a first clock 102, a second clock 104, a first physical timer 106, a second physical timer 108, a virtual timer 110, a frequency offset estimator 112, and a calibration module 114.

The base station 150 is a network entity operable to communicate with one or more devices in a coverage area (e.g., a cell) of the base station 150. The coverage area of the base station 150 may be a macro cell or a small cell (such as a pico cell, a metro cell, a femto cell, or the like). The base station 150 may be located in the fixed or stationary part of the system. The base station 150 may be a (e)NodeB, a home (e)NodeB, an access point, a remote radio head, a relay node, a transmission point, or the like, which may be further divided into a remote unit and a central unit.

The UE 100 and the base station 150 may communicate over a radio link. Any of the radio links between the UE 100 and the base station 150 may operate according to any one or more of the following radio communication technologies and/or standards including, but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), IEEE 802.11 standards in general including 802.11a, 802.11b, 802.11g, 802.11n, and 802.11ac, technologies operating above 300 GHz and THz bands, (3GPP/LTE based or IEEE 802.11p and other) Vehicle-to-Vehicle (V2V) and Vehicle-to-X (V2X) communication technologies, DSRC (Dedicated Short Range Communications) communication systems such as Intelligent-Transport-Systems and others, etc.

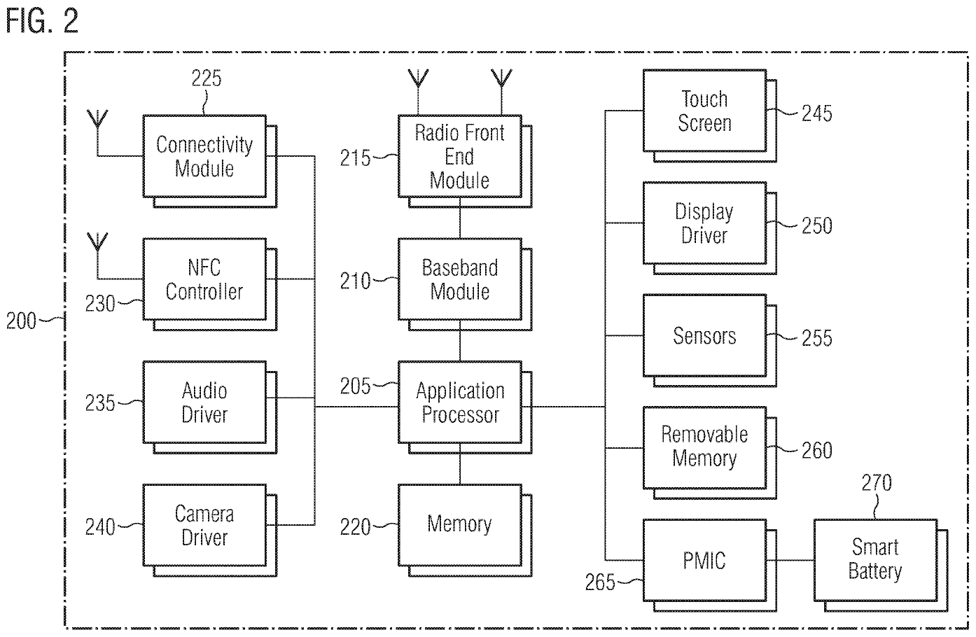

FIG. 2 illustrates the UE 100 in accordance with one aspect. The UE 100 may be a mobile device in some aspects and includes an application processor 205, a baseband processor 210 (also referred to as a baseband module), a radio front end module (RFEM) 215, memory 220, a connectivity module 225, a near field communication (NFC) controller 230, an audio driver 235, a camera driver 240, a touch screen 245, a display driver 250, sensors 255, removable memory 260, power management integrated circuit (PMIC) 265, a smart battery 270, etc.

In some aspects, the application processor 205 may include, for example, one or more CPU cores and one or more of cache memory, low drop-out voltage regulators (LDOs), interrupt controllers, serial interfaces such as serial peripheral interface (SPI), inter-integrated circuit (I2C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, the baseband module 210 may be implemented, for example, as a solder-down substrate including one or more integrated circuits, a single packaged integrated circuit soldered to a main circuit board, and/or a multi-chip module containing two or more integrated circuits.

For power efficient operations, the UE 100 may transition between a long inactive state (i.e. a low power mode) and a short active state in accordance with a pre-configured schedule in an idle state or in a DRX mode. During the inactive state of the UE 100, most parts of the UE 100 including the first clock 102 and the first physical timer 106 may be turned off. However, in order to maintain synchronization with the network, i.e. with the base station 150, the second clock 104 and the second physical timer 108 may be powered on during the inactive state of the UE 100. For power saving and cost reasons, the first clock 102 may be a high frequency, more accurate clock and the second clock 104 may be a low frequency, less accurate clock. Alternatively, the second clock 104 may be a higher frequency, more accurate clock than the first clock 102, or the first clock 102 and the second clock 104 may have the same frequency and accuracy. The first physical timer 106 and the virtual timer 110 may be reestablished and restored based on the second physical timer 108 after the UE 100 wakes up from the inactive state.

The first clock 102 generates a first clock signal, and the second clock generates a second clock signal. The first physical timer 106 and the second physical timer 108 include counters that are incremented periodically by the clock signal from the first clock 102 and the second clock 104, respectively. The resolution of the first physical timer 106 and the second physical timer 108 are given by the frequency of the clock signal and the step size that the counter is incremented with each clock signal. The first physical timer 106 includes a free running counter which is not frequency corrected. For example, the first physical timer 106 may be clocked with 38.4 MHz and count 153.6 MHZ cycles, i.e. the counter is increased by 4 per clock cycle. The first physical timer 106 may provide a physical base for the virtual timer 110 and other radio access technology-specific timers. The first physical timer 106 may start from 0 after hardware reset and may be reestablished after an inactive state based on the second physical timer 108.

The virtual timer 110 is a software-based timer referring to a reference timer. The reference timer may be a physical timer or another virtual timer. In the example of FIG. 1, the virtual timer 110 refers to the first physical timer 106 directly or indirectly. There is a known relationship between the virtual timer 110 and the first physical timer 106 so that a time value of the first physical timer 106 may be converted to a time value of the virtual timer 110, and vice versa.

The virtual timer 110 may be calibrated based on the reference frequency of the network, e.g. the base station 150. A precise absolute time in the UE 100 is maintained by the virtual timer 110 and the first clock 102 may be running freely without being calibrated. The first clock 102 may be shared by other components in the UE 100, for example by the macro-area cellular communication, wireless local area network (WLAN), Bluetooth, Near Field Communication (NFC), frequency modulation (FM) radio, Global Navigation Satellite System (GNSS) components, etc. None of these components may tune the first clock 102 directly and the first clock 102 may be free-running.

The virtual time (i.e. the time maintained by the virtual timer 110) may be obtained by translating any measured frequency offset of the first clock 102 from the reference frequency in a base station 150 to a timing offset between the first clock 102 and the virtual timer 110.

The frequency offset may be defined as a frequency difference of the reference oscillators in the base station 150 and the UE 100. Assuming the base station 150 has a highly stable reference oscillator, the frequency offset may depend on the temperature or the age of the oscillator included in the first clock 102 of the UE 100, and may be estimated based on the carrier frequency offset. The frequency offset estimator 112 measures the frequency offset between the carrier frequency and the UE reference frequency (e.g. the frequency of the first clock 102) using any conventional automatic frequency correction scheme.

The virtual timer 110 is not a physical timer. The virtual timer 110 is not updated per clock cycle, but comprises a database, giving the relation to the reference timer, e.g. the first physical timer 106. The database of the virtual timer 110 includes a correction factor that gives a relation between the first physical timer 106 and the virtual timer 110 such that any time value of the first physical timer 106 and the virtual timer 110 may be converted from the other based on the correction factor. For example, a record in the database of the virtual timer 110 may comprise a reference value to the virtual timer 110 (or the first physical timer 106), a timer offset (difference) between the virtual timer 110 and the first physical timer 106, and a correction factor giving a linear relation between the virtual timer 110 and the first physical timer 106. Alternatively, a record in the database of the virtual timer 110 may comprise a reference value to the virtual timer 110, a reference value to the first physical timer 106, and a correction factor giving a linear relation between the two reference values. The correction factor may be derived from the frequency offset. With this database, the virtual timer value may be calculated from the first timer value, and vice versa.

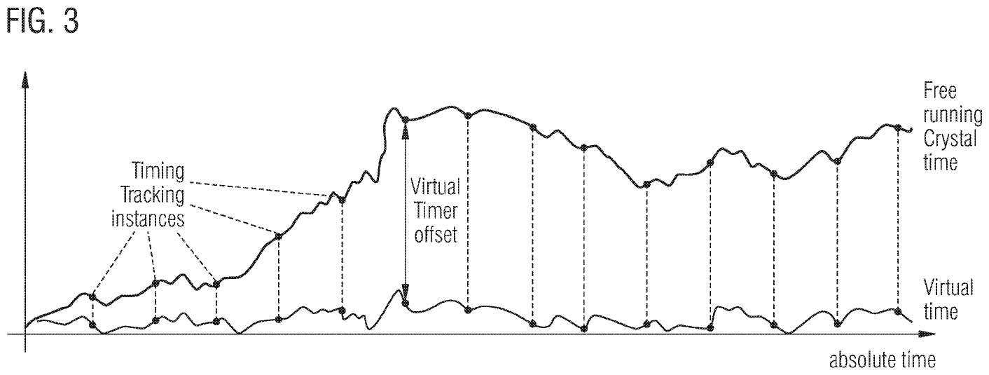

FIG. 3 shows an example of measured timer offsets between the virtual timer 110 and the first physical timer 106. The frequency offset between the reference frequency of the base station 150 and the frequency of the free-running first clock 102 in the UE 100 are measured by the frequency offset estimator 112 at a plurality of time instances, e.g. periodically. In one example, the measured frequency offset may be converted to a time domain correction factor, and the virtual timer 110 may be updated with the time domain correction factor, which will be explained in detail below.

The frequency offset estimator 112 measures the carrier frequency offset f_{CFO}. A positive value of f_{CFO} would mean that the reception frequency of the UE 100 is lower than the base station transmitting frequency, which means that the base station reference runs faster than the UE reference, and a negative value of f_{CFO} would mean that the reception frequency of the UE 100 is higher than the base station transmitting frequency, which means that the UE reference runs faster than the base station reference. The carrier frequency offset may be defined with a factor K as follows:

K×f_{c,UE}=f_{c,BS}, Equation (1)

where f_{c,UE} is the reference frequency of the UE 100 and f_{c,BS} is the reference frequency of the base station 150. K is defined as follows:

K=1+Δα. Equation (2)

Δα may be given in units of ppm or ppb.

(1+Δα)×f_{c,UE}=f_{c,BS}=f_{c,UE}+f_{CFO}; Equation (3)

f_{c,UE}+Δα×f_{c,UE}=f_{c,UE}+f_{CFO}; Equation (4)

Δα×f_{c,UE}=f_{CFO}. Equation (5)

In case the frequency offset estimator 112 detects a current frequency offset value Δf_{CFO} in Hz, the current relative frequency correction factor Δαₙ⁽ⁱ⁾ in automatic frequency correction loop (i) at step n in ppb/4 (ppb=½³⁰) is defined as follows:

$${Δα}_{n}^{( i )} = ⌊ \frac{{f}_{CFO}}{{f}_{c , UE}} \times {2}^{32} ⌋ . \qquad Equation ( 6 )$$

For f_{c,UE}, the nominal carrier frequency can be used for simplicity. Due to the fact that the carrier is corrected and only the remaining frequency offset is seen but the reference frequency at the UE 100 is not corrected, the delta frequency offset factor Δαₙ⁽ⁱ⁾ needs to be accumulated as follows:

αₙ⁽ⁱ⁾=Σₖ₌₀ⁿΔαₖ⁽ⁱ⁾=(Σₖ₌₀ⁿ⁻¹Δαₖ⁽ⁱ⁾)+Δαₙ⁽ⁱ⁾=αₙ₋₁⁽ⁱ⁾+Δαₙⁱ. Equation (7)

This correction factor can be applied to the virtual timer frequency. The frequency calibrated virtual timer frequency f_{VT} would be:

$${f}_{VT} = ( 1 + \frac{{α}_{n}^{( i )}}{{2}^{32}} ) \times {f}_{ref} \times 4 , \qquad Equation ( 8 )$$

where f_{ref} is the free-running reference clock frequency at the UE 100. A positive value of f_{CFO} would lead to a positive value of Δαₙ⁽ⁱ⁾ and this would lead to an increased virtual timer frequency, which is needed in case where the UE reference is slower than the base station reference, and a negative value of f_{CFO} would lead to a negative value of Δαₙ⁽ⁱ⁾ and this would lead to a decreased virtual timer frequency, which is needed in case where the UE reference is faster than the base station reference.

The counting period of the virtual timer 110 is defined as follows:

$${T}_{VT} = ( 1 + \frac{{β}_{n}^{( i )}}{{2}^{32}} ) \cdot {T}_{ref} \text{/} 4 , \qquad Equation ( 9 )$$

where βₙ⁽ⁱ⁾ is the time domain correction factor of the virtual timer 110.

$$\begin{matrix}{T}_{VT} = \frac{1}{{f}_{VT}} = \frac{1}{( 1 + \frac{{α}_{n}^{( i )}}{{2}^{32}} )} \times \frac{{T}_{ref}}{4} , & Equation ( 10 ) \\ ( 1 + \frac{{β}_{n}^{( i )}}{{2}^{32}} ) \times \frac{{T}_{ref}}{4} = \frac{1}{( 1 + \frac{{α}_{n}^{( i )}}{{2}^{32}} )} \times \frac{{T}_{ref}}{4} , & Equation ( 11 ) \\ ( 1 + \frac{{β}_{n}^{( i )}}{{2}^{32}} ) = \frac{1}{( 1 + \frac{{α}_{n}^{( i )}}{{2}^{32}} )} . & Equation ( 12 )\end{matrix}$$

The relation between αₙ⁽ⁱ⁾ and βₙ⁽ⁱ⁾ can be given as follows:

$${β}_{n}^{( i )} = \frac{- {α}_{n}^{( i )}}{1 + \frac{{α}_{n}^{( i )}}{{2}^{32}}} . \qquad Equation ( 13 )$$

Due to the fact that αₙ⁽ⁱ⁾<<2³², it can be simplified as follows:

βₙ⁽ⁱ⁾≈−αₙ⁽ⁱ⁾. Equation (14)

The value βₙ⁽ⁱ⁾ is passed to the calibration module 114 for updating the virtual timer 110. The virtual timer offset (i.e. the difference between the virtual timer 110 and the first physical timer 106) and the virtual time may also be calculated with the time domain correction factor βₙ⁽ⁱ⁾ and the virtual timer 110 may be updated with the virtual timer offset and/or the virtual time.

During the inactive state of the UE 100, the second clock 104 keeps running, but a drift of the second clock 104 may occur. One measure to reduce the accumulated drift is to upfront measure the drift between a precise reference clock and the second clock 104 (i.e. a low accuracy inactive clock) with a special measurement hardware. Knowing the drift allows to compensate it for the inactive time, except for the drift changes which may happen during the inactive phase itself. For example, assuming that the inactive drift is known precisely when the inactive phase begins and the drift change is limited to 0.5 ppm/sec, the accumulated timing drift would be limited to 2.56 sec×0.5 ppm/sec=1.28 ppm after 2.56 sec (in case of 2.56 sec DRX), and the average drift error would be less than ½×1.28 ppm=0.64 ppm during the inactive time, which means that the accumulated timing error shall be smaller than 0.64 ppm×2.56 sec=1.64 μs. In this case, the error can be kept below the assumed window size of ±4 μsec.

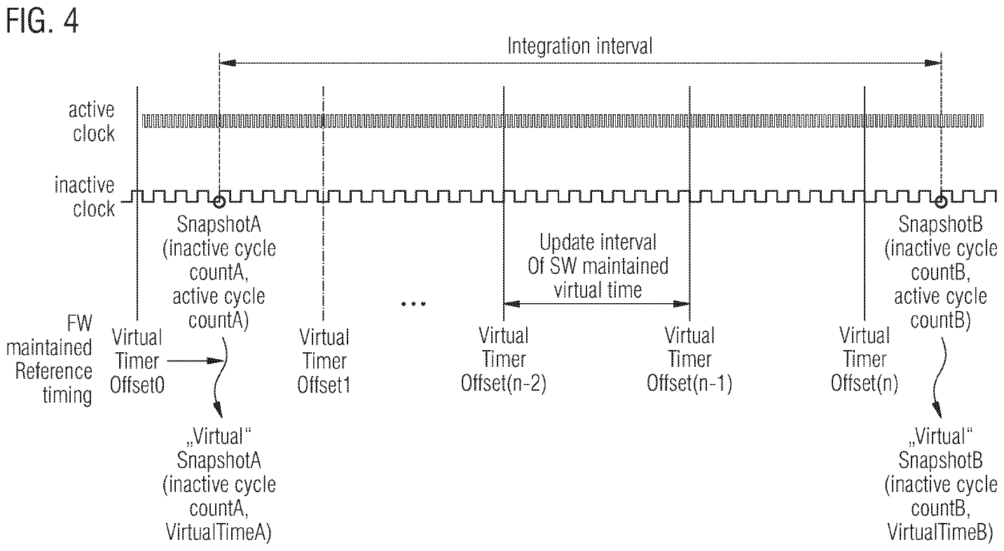

FIG. 4 shows an example of measuring a drift of the second clock 104 based on the virtual timer 110. As shown in FIG. 4, the virtual timer offsets, virtual timer offset(0), virtual timer offset(1) . . . virtual timer offset(n), may be periodically measured and the virtual timer 110 may be updated periodically as disclosed above. The drift measurement is done by taking timer values of the first physical timer 106 and the second physical timer 108 at the first and second time instances, respectively (shown as snapshot A and snapshot B in FIG. 4). Two pairs of snapshots may be generated as: snapshot A(second clock count A, first clock count A) and snapshot B(second clock count B, first clock count B). The second snapshot pair (snapshot B) may be taken shortly before the start of the inactive state of the UE 100. The first and second time instances (i.e. the time period between snapshot A and snapshot B) are separated by an integration interval. As the first clock 102 is not compensated the snapshot pairs may not be enough to estimate the absolute clock drift of the second clock 104.

As the software maintains the virtual time (e.g. as an offset to the first physical timer 106) in regular time intervals the snapshot pairs (snapshot A and snapshot B) can be converted to virtual snapshot A(second clock count A, virtual time A) and virtual snapshot B(second clock count B, virtual time B), respectively. For example, the virtual time may be calculated by adding the most recent virtual timer offset to the first clock counts (e.g. by adding virtual timer offset(0) to the first clock count A, and by adding virtual timer offset(n) to the first clock count B in the example of FIG. 4). Alternatively, the conversion of the first clock value to the virtual time may be done by interpolating or extrapolating the preceding and/or succeeding virtual timer values. Alternatively, the conversion of the first clock value to the virtual time may be done using the time domain correction factor (βₙ) and the preceding virtual timer value.

With the converted virtual snapshot pairs at two different time instances, an estimation of the drift of the second clock 104 can be estimated as follows:

$$Drift = \frac{\begin{matrix}( second clock count B - \\ second clock count A ) \times \\ norminal first clock frequency\end{matrix}}{\begin{matrix}( virtual time B - virtual time A ) \times \\ norminal second clock frequency\end{matrix}} . \qquad Equation ( 15 )$$

The first physical timer 106 may be reestablished based on the second physical timer 108 and the virtual timer 110 may be restored based on the above pre-measured drift value and the second physical timer 108 after the UE 100 wakes up from the inactive state.

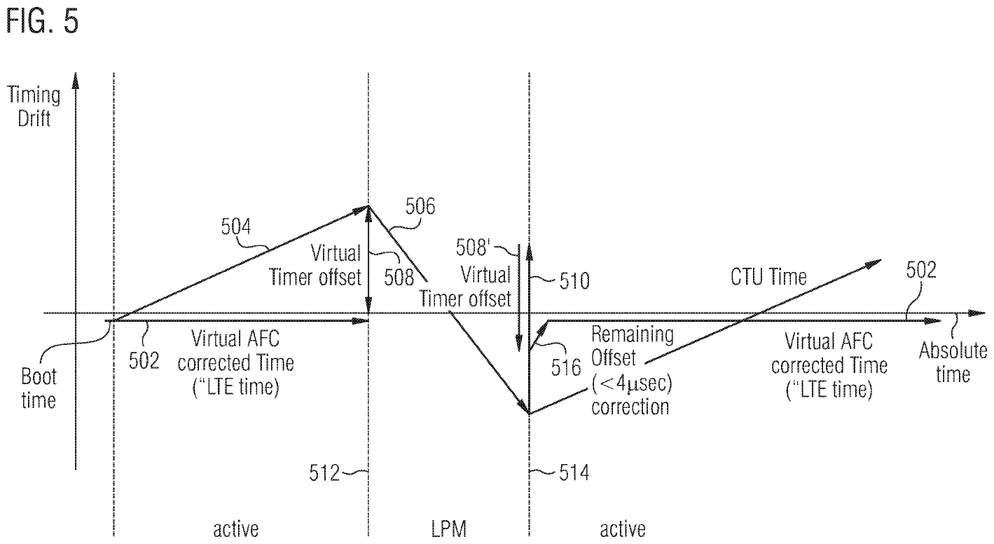

FIG. 5 shows an example of timing recovery concept based on the drift measurement after the UE wakes up from the inactive state. Since the virtual timer 110 is frequency corrected during the active state of the UE 100, the virtual time traces the absolute time (the timing offset 502 of the virtual timer 110 is ideally zero). As the first physical timer 106 is free running, a timing offset of the first physical timer 106 may occur during the active state of the UE 100, as indicated by arrow 504 (the timing offset linearly increases in this example). After the UE 100 enters into an inactive state (e.g. a low power mode(LPM)) at time 512, the time is then maintained by the second physical timer 108 while the first clock 102 and the first physical timer 106 are turned off. The second clock 104 may drift, as indicated by arrow 506. After the UE 100 wakes up from the inactive state at time 514, the first physical timer 106 may be reconstructed based on the second physical timer 108, and the virtual timer 110 may be restored based on the second physical timer 108 and a drift compensation. A drift compensation that is calculated based on the pre-measured drift of the second physical clock 104 is added to or subtracted from the timer value maintained based on the second physical timer 108, as indicated by arrow 510, and the virtual timer offset 508 calculated for the start time 512 of the inactive state is further added to or subtracted from the resulting value (as indicated by arrow 508′). The drift compensation 510 may be calculated by multiplying the pre-measured drift according to Equation (15) to the inactivity period. After the timing recovery using the virtual timer 110 in accordance with examples disclosed herein, the recovered timing might not completely be aligned with the network reference timing, and there might be a remaining timing offset. The remaining timing offset may be eliminated by a measurement of the network reference cell.

In accordance with the examples disclosed herein, it is possible to measure the drift of the second clock 104 (i.e. the inactive clock) against a precise reference timing without having a drift-compensated active hardware clock. In the examples disclosed herein, it is the software that keeps track of the timing offset between the free running hardware clock and the network time in regular time intervals. Instead of an integrated hardware drift measurement, a simple timer snapshot is needed by hardware.

Conventional solutions either need to use low power mode clocks with better performance, i.e. higher absolute accuracy, or shorter inactive phases. Alternatively, the conventional solutions need to implement an accurate active hardware clock as a reference for the hardware clock drift measurement. The examples disclosed herein combine low cost requirements (i.e. usage of an active mode clock and a cheap inactive clock) with high timing accuracy for the timing recovery after an inactive phase of a UE 100. The examples disclosed herein can avoid complicated hardware support and give high flexibility on the integration interval of the drift measurement.

In accordance with the examples disclosed herein, the distance between the two time instances that the timer snapshots are taken (i.e. the integration interval) may be kept or adjusted dynamically. This is not so flexible in a conventional hardware-based clock drift measurement. At the beginning when any measurement has not been performed the integration interval for the drift measurement may be kept short to allow a first usable drift value. Later after the inactive clock drift value has settled the integration interval may be increased to reduce noise effects in the drift measurement (e.g. quantization noise due to the absolute length of the first clock). There would be a tradeoff between noise reduction and timeliness of the drift calculation. A short integration interval would increase the noise, but improve the timeliness whereas a long integration interval would decrease the noise, but average the measurements over a long interval.

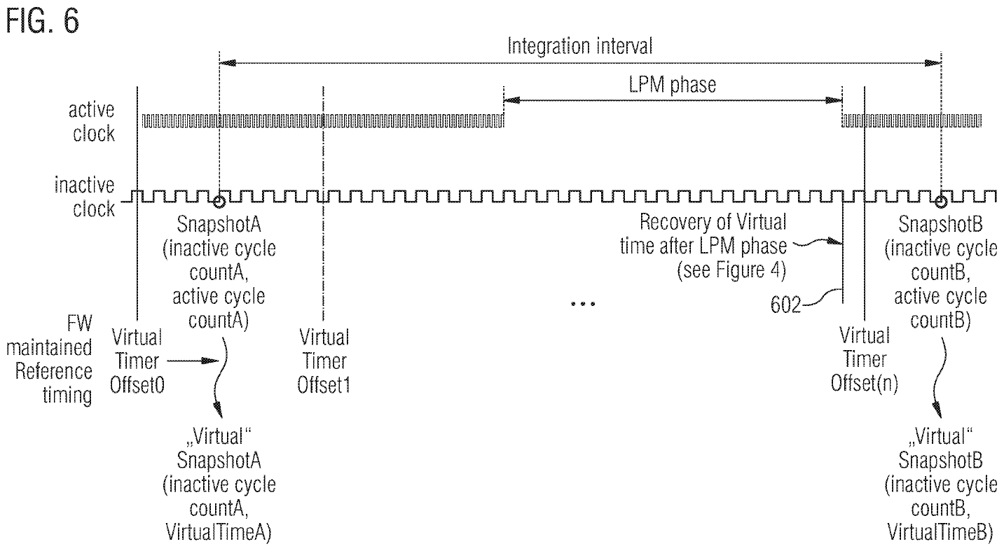

In accordance with another example, the first clock 102 may not be needed to be available for the whole time for measuring the drift of the second clock 104, i.e. between the first and the second snapshots in FIG. 4. If the possible drift change allows it, the integration interval that the two pairs of the first timer value and the second timer value are taken may include a long inactive phase, and may include zero, one, or more than one inactive state of the UE 100. FIG. 6 shows an example of the second clock drift measurement over an integration interval that includes an inactive state of the UE 100. As shown in FIG. 6, the integration interval for measuring the drift of the second clock 104 may include an inactive state. At the end of the inactive state at 602, the virtual timer 110 is recovered as explained above with respect to FIG. 5.

The examples disclosed above were explained with reference the case where the active clock (i.e. the first clock 102) is free-running without being calibrated. However, the examples disclosed above may also be applied to the case where the active clock (i.e. the first clock 102) is calibrated.

The platforms of a wireless communication device, such as a mobile phone, typically contain two fundamentally different clock sources. The first one is a high-speed clock that is used during active operation of the wireless communication device, and the second one is an always-on low-speed clock that is used during inactivity periods, for example counting the sleep duration, and allows for very low power consumption.

In order to reduce platform costs as well as allow sharing with other components the high speed clocks are implemented as temperature-sensing crystal (TSX). Compared to a voltage-controlled temperature-compensated crystal oscillator (VCTCXO) the TSX is cheaper and smaller. However, the temperature compensation needs to be handled via software mechanism inside a device (e.g. a modem).

While in a connected mode the frequency tuning is done very often and thus the impact of thermal drifts is low. However, this is not the case in an idle mode. For example, the low speed clock may be implemented as 32 kHz temperature-compensated crystal oscillator (TCXO) and handle the wake-up and sleep duration of the platform. When the high speed clock is switched off the low speed clock takes over. As the low speed clock is temperature-compensated the wake-up time may be very accurate even under thermal drift. At wake-up time, the high speed clock is switched on again. Due to the thermal drift the frequency of the high speed clock may have been changed during the sleep period and need to be corrected. This is typically done via software mechanism using the known or learned function between temperature and frequency offset of the high speed clock. However, the frequency offset of the high speed clock might still be high (>1 ppm) and thus the data reception might fail.

Conventionally, this is typically avoided by predicting the worst-case deviation expected after wake-up and planning additional activities, such as intermediate wake-up, earlier wake-up, or the like, to avoid this situation. These activities however require additional activity periods in the order of 10 to 50 ms which then adds up a significant amount of extra energy consumption, thus limiting the operation time of the wireless communication device.

In examples below, an alternative approach is disclosed to handle the initial frequency correction of the high speed clock after wake-up via frequency relation estimation against the low speed temperature-compensated clock. This approach has advantages of very small additional activity periods as well as independence from life time learning state and specific radio access technology (RAT). The examples disclosed herein may also be used to achieve a better frequency accuracy at initial cell search (i.e. without prior connection to the network) and thus speed up the cell search procedure. The temperature-compensated low speed clock is used as a reference for the platform and the associated frequency correction may be applied to a phase locked loop (PLL). The examples disclosed herein are more power efficient than the conventional implementation.

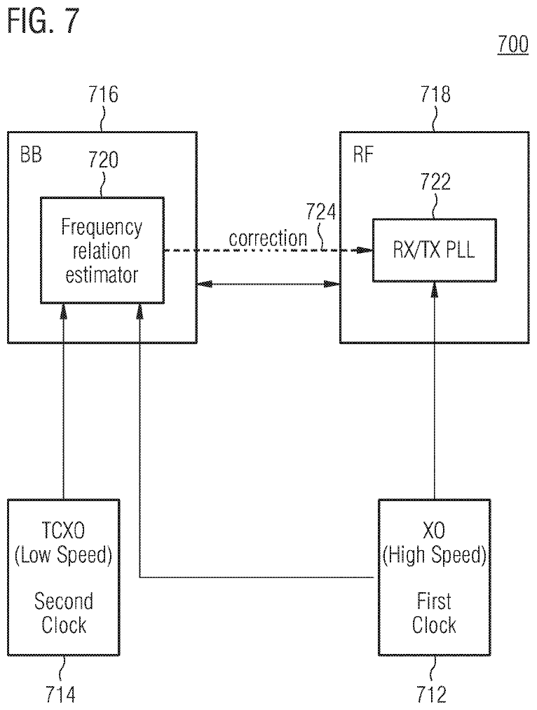

FIG. 7 shows a wireless communication device 700 configured to implement clock calibration in accordance with one example. The device 700 may be a UE, for example as shown in FIGS. 1 and 2. In some examples, the device 700 may include a first clock 712, a second clock 714, a baseband processor 716, and a radio frequency (RF) processor 718. The first clock 712 generates first clock signals with a first frequency and the second clock 714 generates second clock signals with a second frequency. The first frequency may be higher than the second frequency. For example, the first clock 712 may be an uncompensated temperature-incorrect high speed clock (e.g. 26 or 38.4 MHz crystal oscillator (XO)/TSX), and the second clock 714 may be a temperature-compensated low speed clock (e.g. 32 kHz TCXO). The first clock 712 may be calibrated once at a factory at fabrication temperature (e.g. 27° C.) and may not be calibrated thereafter.

The baseband processor 716 may include a clock frequency relation estimator (CFRE) 720. The RF processor 718 may include a transmit/receive PLL(s) 722 clocked by the first clock 712 for generating clock signals in specific frequencies for different RATs. The clock frequency relation estimator 720, which may be a hardware circuit or a combination of hardware circuit and software, receives clock signals from the first clock 712 and the second clock 714 and calculates a frequency relation (e.g. a frequency ratio, a frequency difference, or the like) between the first clock signal and the second clock signal. Example methods and system for determining the frequency relation between the two clock signals are disclosed in U.S. Patent Publication No. 2015/0074444 which is incorporated herein by reference as if fully set forth. The clock frequency relation estimator 720 generates a correction signal 724 based on the calculated frequency relation and sends the correction signal 724 to the PLL 722 for frequency adjustment.

The baseband processor 716 and the RF processor 718 may be integrated in a single chip or may be separate. The clock frequency relation estimator 720 may be included in the baseband processor 716 as shown in FIG. 7, or as an alternative may be included in the RF processor 718. The PLL 722 may be included in the baseband processor 716 or may be included in both the baseband processor 716 and the RF processor 718.

In the conventional implementations, to handle the frequency deviation of the high speed clock due to temperature change, the dependency of the frequency to temperature of the high speed clock may be learned starting with an average default value based on factory initialization. Especially at an early learning stage or very high or low temperatures the deviation between the assumed and real behaviors of the high speed clock may be high. This may affect the idle mode wake-up procedures where a big frequency deviation, relative to the base station, may not be handled by the device (i.e. a receiver) and may lead to a loss of paging. This problem can be solved by the examples disclosed herein.

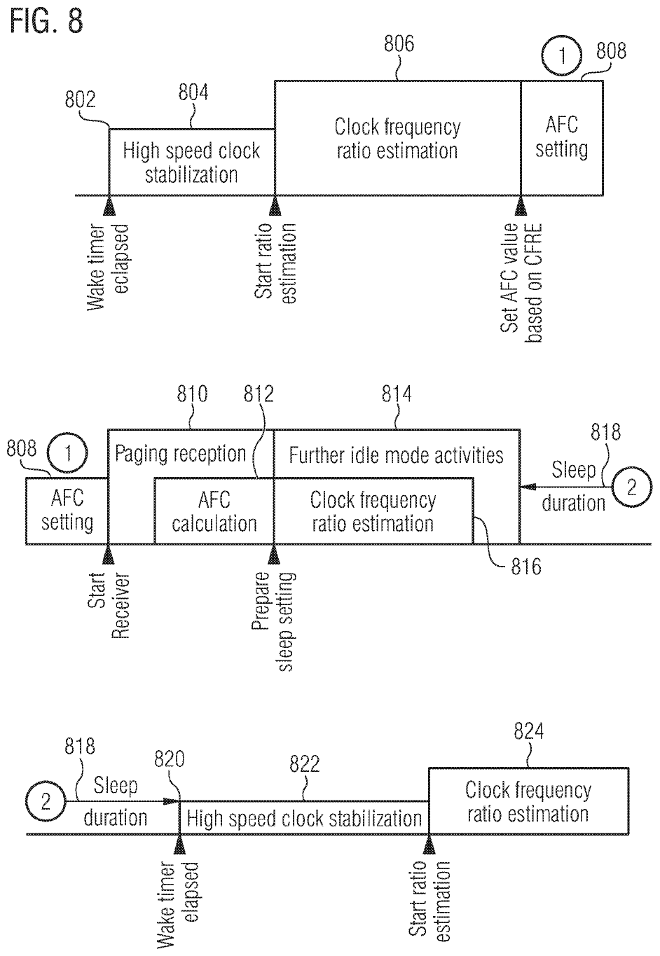

FIG. 8 shows an example procedure of clock calibration after waking up from an inactive state for receiving a paging message. The wireless communication device 700 may enter into an inactive state (e.g. a sleep state or a DRX) periodically or upon a trigger, etc. The sleep duration elapses according to the programmed value for the second clock 714 (e.g. a low speed clock). Following a trigger by the second clock 714, the first clock 712 (e.g. a high speed clock) is activated (802). Since the second clock 714 is temperature compensated, the point in time the system is woken up may be very accurate and may not depend on the thermal drift. Therefore, different RATs may not need to take additional procedures to handle a big timing offset. Following the activation, the first clock 712 needs some time (e.g. typically several milliseconds) to be stabilized sufficiently (804).

Before the actual reception of the paging channel from the network, the clock frequency relation estimator 720 is started and the frequency relation (e.g. the frequency ratio, the frequency difference, or the like) between the first clock 712 and the second clock 714 is calculated (806). Due to its temperature compensation the second clock 714 may be assumed to be the local clock frequency reference.

For example, the frequency ratio estimation between the first clock 712 and the second clock 714, (i.e. determination of the frequency relation between the high speed clock signal and the low speed clock signal), may be done by counting the number of first clock cycles versus a pre-determined number of second clock cycles. The frequency relationship (e.g. the frequency difference) between the first clock and the second clock may be determined by sampling the first clock signals at sampling times given by the second clock and determining the frequency relationship such that the expected sample values (which depend from the determined frequency relationship) fit the actual sample values according to a predetermined measure.

The calculation and capturing of measurements for the estimation of the frequency relation with very good quality below ±0.5 ppm may take about 4 to 6 ms. In case less accuracy is allowable the time may be further reduced (e.g. below 1 ms) and may be much faster than any intermediate wake-ups or RAT frequency measurements that otherwise would be used to avoid a high frequency drift.

A correction signal for setting an AFC in the PLL(s) 722 is then generated based on the estimated frequency relation to compensate for the thermal or aging induced drift (808). Due to the high quality of the clock frequency ratio estimation and the thermal compensation of the second clock 714 the residual frequency offset seen by each RAT may be handled by the respective receiver without further enhancement. This means that a complicated, time consuming and error prone learning of the frequency drift to temperature compensation of the first clock 712 may not be required for idle mode handling.

After adjusting the PLL 722, a receiver of the wireless communication device 700 receives a paging channel (810). After receiving the paging channel from the network, the device 700 may execute frequency measurements on a network reference signal (e.g. a pilot channel) and calculate a frequency error for setting the AFC in the PLL 722 based on the received network reference signal (812). The calculated frequency error (i.e. AFC correction value) is then used to further adapt the PLL 722 to the network reference clock.

After further idle mode activities are performed (814), the wireless communication device 700 may enter into an inactive state (a sleep state). The estimation of the frequency ratio between the second clock 714 against the first clock 712 may be performed again to allow the best possible starting point for the enabling of the sleep mode and calculation of sleep time (816). The frequency ratio between the second clock 714 and the actual network reference clock may be needed, for example for calculating the sleep time. This value may be calculated in advance, for example after receiving a paging message and thus getting frequency measurement from the respective RAT. The frequency ratio between the second clock 714 and the first clock 712 (after the first clock 712 is synchronized to the network) may be needed as preparation for the frequency adaptation at wake-up, i.e. in order to know how changes of the second clock 714 relate to the first clock 712 changes.

After entering into a sleep state (818), the above procedure may repeat for waking up (820), activation and stabilization of the first clock 712 (822), and clock frequency relation estimation between the first clock 712 and the second clock 714 (824).

The examples disclosed above may be implemented for performing an initial cell search. In a conventional system a non-temperature-corrected high speed clock is used for cell search. When a wireless communication device is switched on, the first activity is to find a network/cell to connect to. In order to do this the wireless communication device has to scan certain frequency bands. This process depends on the frequency accuracy vs. temperature of the used clock. Typically, a clock (i.e. a crystal oscillator) can show up to 10-15 ppm frequency deviation over temperature compared to the factory calibration. The wireless communication device needs to take these uncertainties into account when doing a cell search e.g. using several frequency hypotheses to compensate for the limited frequency search range covered by the individual RAT searcher. These tests may be implemented by simply repeating the search process until the whole frequency window is covered, which significantly increases the search duration. In one example, a similar approach as used for the idle mode/paging reception may be used to reduce the cell search duration significantly.

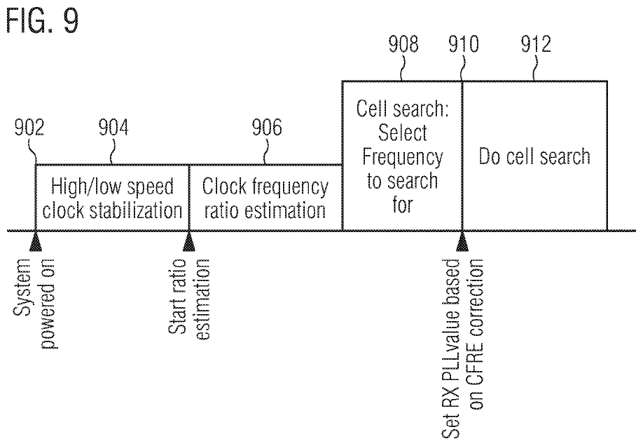

FIG. 9 shows an example procedure of clock calibration after powering up the wireless communication device 700 and for performing a cell search. After the wireless communication device 700 is switched on (902), the first clock 712 (e.g. a high speed temperature incorrect clock) and the second clock 714 (e.g. a low speed temperature compensated clock) are also enabled. It takes some time for stabilization of the first clock 712 and the second clock 714 (904). The second clock is temperature-compensated after activated and such temperature compensation may allow for an accuracy of 1-5 ppm over the complete temperature range for the second clock 714.

After the locking time of the first clock 712 and the second clock 714 (i.e. after stabilization of the first clock 712 and the second clock 714), the clock frequency relation estimator 720 is started, and the first clock 712 and the second clock 714 provide clock signals to the clock frequency relation estimator 720, and a frequency relation of the first clock 712 and the second clock 714 is measured (906). The frequency to search for initial cell selection is selected (908), and the estimated frequency relation is then used to correct the RX PLL 722 (910). The device 700 then performs the cell search (912). This scheme may reduce the frequency accuracy to 1-5 ppm for the first clock 712 and thus allows to use a single cell search activity irrespective of the learning state or temperature of the first clock 712.

In accordance with another example, a machine-readable medium including codes (machine-readable instructions) is provided. The codes/machine-readable instructions, when executed on a computer, a processor, a programmable hardware component, or the like, may cause a machine to perform at least one of the methods and examples described herein.

The examples as described herein may be summarized as follows:

Example 1 is a method for clock calibration in a wireless communication device. The method comprises activating a first clock either after waking up from an inactive state of the wireless communication device or after powering up the wireless communication device, wherein a second clock is configured to run during the inactive state, calculating a correction measure for restoring a timing basis, and restoring the timing basis based on the measure.

Example 2 is the method of example 1, wherein the correction measure is a drift of the second clock incurred while running during the inactive state, and the timing basis is a virtual timer that is a software-based timer calibrated based on a network reference frequency.

Example 3 is the method of example 2, further comprising measuring a frequency offset of the first clock to the network reference frequency based on a signal received from a network, updating the virtual timer based on the frequency offset, measuring the drift of the second clock over a predetermined time interval based on the virtual timer while the wireless communication device is in an active state, and restoring the virtual timer based on the drift after the wireless communication device wakes up from the inactive state.

Example 4 is the method of example 3, wherein the virtual timer comprises a database including a correction factor indicating a relation between the virtual timer and a first physical timer that is clocked by the first clock such that a time tracked by the first physical timer and a time tracked by the virtual timer are converted from each other based on the correction factor.

Example 5 is the method of example 4, wherein the drift is calculated by capturing two pairs of timer values of the first physical timer and a second physical timer that is clocked by the second clock at time instances separated by the predetermined time interval, converting the two pairs of timer values of the first physical timer and the second physical timer to two pairs of timer values of the virtual timer and the second physical timer based on timer offsets between the virtual timer and the first physical timer at the time instances, respectively, and calculating the drift of the second clock based on the two pairs of timer values of the virtual timer and the second physical timer.

Example 6 is the method of example 4, wherein the drift is measured as a ratio of a time measured by the second clock to a time measured by the virtual timer over the predetermined time interval.

Example 7 is the method as in any one of examples 3-6, wherein zero, one, or more than one inactive state of the wireless communication device exists during the predetermined time interval.

Example 8 is the method as in any one of examples 3-6, wherein the predetermined time interval is set dynamically.

Example 9 is the method of example 1, wherein the correction measure is a frequency relation between the first clock and the second clock and the timing basis is a PLL for generating clock signals.

Example 10 is the method of example 9, wherein the frequency relation is measured after waking up from the inactive state or powering up the wireless communication device, and the PLL is controlled based on the frequency relation.

Example 11 is the method of example 9, further comprising receiving a network reference signal after adjusting the PLL, and controlling the PLL based on the network reference signal.

Example 12 is the method as in any one of examples 9-11, wherein the first clock is not temperature compensated and the second clock is temperature compensated.

Example 13 is a device for clock calibration in a wireless communication device. The device comprises a first clock for providing a first clock signal during an active state of the wireless communication device, wherein the first clock is configured to be inactive during an inactive state of the wireless communication device, a second clock for providing a second clock signal, wherein the second clock is configured to run during the inactive state, and a calibration unit configured to calculate a correction measure for restoring a timing basis either after waking up from the inactive state or after powering up the wireless communication device, and restore the timing basis based on the correction measure.

Example 14 is the device of example 13, wherein the correction measure is a drift of the second clock incurred while running during the inactive state, and the timing basis is a virtual timer that is a software-based timer calibrated based on a network reference frequency.

Example 15 is the device of example 14, further comprises a frequency offset estimator for measuring a frequency offset of the first clock to the network reference frequency based on a signal received from a network, wherein the calibration unit is configured to update the virtual timer based on the frequency offset, measure the drift of the second clock over a predetermined time interval based on the virtual timer while the wireless communication device is in an active state, and restore the virtual timer based on the drift after the wireless communication device wakes up from the inactive state.

Example 16 is the device of example 14, wherein the virtual timer comprises a database including a correction factor indicating a relation between the virtual timer and a first physical timer that is clocked by the first clock such that a time tracked by the first physical timer and a time tracked by the virtual timer are converted from each other based on the correction factor.

Example 17 is the device of example 16, wherein the calibration unit is configured to capture two pairs of timer values of the first physical timer and a second physical timer that is clocked by the second clock at time instances separated by the predetermined time interval, convert the two pairs of timer values of the first physical timer and the second physical timer to two pairs of timer values of the virtual timer and the second physical timer based on timer offsets between the virtual timer and the first physical timer at the time instances, respectively, and calculate the drift of the second clock based on the two pairs of timer values of the virtual timer and the second physical timer.

Example 18 is the device of example 16, wherein the drift is measured as a ratio of a time measured by the second clock to a time measured by the virtual timer over the predetermined time interval.

Example 19 is the device as in any one of examples 14-18, wherein zero, one, or more than one inactive state of the wireless communication device exists during the predetermined time interval.

Example 20 is the device as in any one of examples 14-18, wherein the predetermined time interval is set dynamically.

Example 21 is the device of example 13, wherein the correction measure is a frequency relation between the first clock and the second clock, and the timing basis is a transmit/receive PLL for generating clock signals.

Example 22 is the device of example 21, wherein the frequency relation is measured after waking up from the inactive state or powering up the wireless communication device, and the PLL is controlled based on the frequency relation.

Example 23 is the device of example 21, wherein the calibration unit is configured to adjust the PLL based on a network reference signal.

Example 24 is the device as in any one of examples 21-23, wherein the first clock is not temperature compensated and the second clock is temperature compensated.

Example 25 is a device for clock calibration. The device comprises means for generating a first clock signal during an active state of a wireless communication device, wherein the means for generating the first clock signal is configured to be inactive during an inactive state of the wireless communication device, means for generating a second clock signal, wherein the means for generating the second clock signal is configured to run during the inactive state, and means for calculating a correction measure for restoring a timing basis either after waking up from the inactive state or after powering up the wireless communication device, and restoring the timing basis based on the correction measure.

Example 26 is the device of example 25, wherein the correction measure is a drift of the means for generating a second clock signal incurred while running during the inactive state, and the timing basis is a virtual timer that is a software-based timer calibrated based on a network reference frequency.

Example 27 is the device of example 26, further comprises means for measuring a frequency offset of the means for generating the first clock signal to the network reference frequency based on a signal received from a network, means for updating the virtual timer based on the frequency offset, means for measuring the drift of the means for generating the second clock signal over a predetermined time interval based on the virtual timer while the wireless communication device is in an active state, and means for restoring the virtual timer based on the drift after the wireless communication device wakes up from the inactive state.

Example 28 is the device of example 27, wherein the virtual timer comprises a database including a correction factor indicating a relation between the virtual timer and a first physical timer that is clocked by the means for generating the first clock signal such that a time tracked by the first physical timer and a time tracked by the virtual timer are converted from each other based on the correction factor.

Example 29 is the device of example 28, wherein the means for measuring the drift comprises means for capturing two pairs of timer values of the first physical timer and a second physical timer that is clocked by the means for generating the second clock signal at time instances separated by the predetermined time interval, means for converting the two pairs of timer values of the first physical timer and the second physical timer to two pairs of timer values of the virtual timer and the second physical timer based on timer offsets between the virtual timer and the first physical timer at the time instances, respectively, and means for calculating the drift of the second clock based on the two pairs of timer values of the virtual timer and the second physical timer.

Example 30 is the device of example 28, wherein the drift is measured as a ratio of a time measured by the means for generating the second clock signal to a time measured by the virtual timer over the predetermined time interval.

Example 31 is the device as in any one of examples 27-30, wherein zero, one, or more than one inactive state of the wireless communication device exists during the predetermined time interval.

Example 32 is the device as in any one of examples 27-30, wherein the predetermined time interval is set dynamically.

Example 33 is the device of example 25, wherein the correction measure is a frequency relation between the means for generating the first clock signal and the means for generating the second clock signal and the timing basis is a PLL for generating clock signals.

Example 34 is the device of example 33, wherein the frequency relation is measured after waking up from the inactive state or powering up the wireless communication device, and the PLL is controlled based on the frequency relation.

Example 35 is the device of example 33, further comprises means for receiving a network reference signal after adjusting the PLL, and means for controlling the PLL based on the network reference signal.

Example 36 is the device as in any one of examples 33-35, wherein the means for generating the first clock signal is not temperature compensated and the means for generating the second clock is temperature compensated.

Example 37 is a machine-readable storage medium including codes, when executed, to cause a machine to perform a method as in any one of examples 1-12.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means” etc., may be implemented in the form of dedicated hardware, such as “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared.

However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for clock calibration in a wireless communication device, the method comprising:
activating a first clock either after waking up from an inactive state of the wireless communication device or after powering up the wireless communication device, wherein a second clock is configured to run during the inactive state;
calculating a correction measure for restoring a timing basis; and
restoring the timing basis based on the measure.

2. The method of claim 1, wherein the correction measure is a drift of the second clock incurred while running during the inactive state, and the timing basis is a virtual timer that is a software-based timer calibrated based on a network reference frequency.

3. The method of claim 2, further comprising:
measuring a frequency offset of the first clock to the network reference frequency based on a signal received from a network;
updating the virtual timer based on the frequency offset;
measuring the drift of the second clock over a predetermined time interval based on the virtual timer while the wireless communication device is in an active state; and
restoring the virtual timer based on the drift after the wireless communication device wakes up from the inactive state.

4. The method of claim 3, wherein the virtual timer comprises a database including a correction factor indicating a relation between the virtual timer and a first physical timer that is clocked by the first clock such that a time tracked by the first physical timer and a time tracked by the virtual timer are converted from each other based on the correction factor.

5. The method of claim 4, wherein the drift is calculated by:
capturing two pairs of timer values of the first physical timer and a second physical timer that is clocked by the second clock at time instances separated by the predetermined time interval;
converting the two pairs of timer values of the first physical timer and the second physical timer to two pairs of timer values of the virtual timer and the second physical timer based on timer offsets between the virtual timer and the first physical timer at the time instances, respectively; and
calculating the drift of the second clock based on the two pairs of timer values of the virtual timer and the second physical timer.

6. The method of claim 4, wherein the drift is measured as a ratio of a time measured by the second clock to a time measured by the virtual timer over the predetermined time interval.

7. The method of claim 3, wherein zero, one, or more than one inactive state of the wireless communication device exists during the predetermined time interval.

8. The method of claim 3, wherein the predetermined time interval is set dynamically.

9. The method of claim 1, wherein the correction measure is a frequency relation between the first clock and the second clock and the timing basis is a phase locked loop (PLL) for generating clock signals.

10. The method of claim 9, wherein the frequency relation is measured after waking up from the inactive state or powering up the wireless communication device, and the PLL is controlled based on the frequency relation.

11. The method of claim 9, further comprising:
receiving a network reference signal after adjusting the PLL; and
controlling the PLL based on the network reference signal.

12. The method claim 9, wherein the first clock is not temperature compensated and the second clock is temperature compensated.

13. A device for clock calibration in a wireless communication device, the device comprising:
a first clock for providing a first clock signal during an active state of the wireless communication device, wherein the first clock is configured to be inactive during an inactive state of the wireless communication device;
a second clock for providing a second clock signal, wherein the second clock is configured to run during the inactive state; and
a calibration unit configured to calculate a correction measure for restoring a timing basis either after waking up from the inactive state or after powering up the wireless communication device, and restore the timing basis based on the correction measure.

14. The device of claim 13, wherein the correction measure is a drift of the second clock incurred while running during the inactive state, and the timing basis is a virtual timer that is a software-based timer calibrated based on a network reference frequency.

15. The device of claim 14, further comprising:
a frequency offset estimator for measuring a frequency offset of the first clock to the network reference frequency based on a signal received from a network,
wherein the calibration unit is configured to update the virtual timer based on the frequency offset, measure the drift of the second clock over a predetermined time interval based on the virtual timer while the wireless communication device is in an active state, and restore the virtual timer based on the drift after the wireless communication device wakes up from the inactive state.

16. The device of claim 14, wherein the virtual timer comprises a database including a correction factor indicating a relation between the virtual timer and a first physical timer that is clocked by the first clock such that a time tracked by the first physical timer and a time tracked by the virtual timer are converted from each other based on the correction factor.

17. The device of claim 16, wherein the calibration unit is configured to capture two pairs of timer values of the first physical timer and a second physical timer that is clocked by the second clock at time instances separated by the predetermined time interval, convert the two pairs of timer values of the first physical timer and the second physical timer to two pairs of timer values of the virtual timer and the second physical timer based on timer offsets between the virtual timer and the first physical timer at the time instances, respectively, and calculate the drift of the second clock based on the two pairs of timer values of the virtual timer and the second physical timer.

18. The device of claim 16, wherein the drift is measured as a ratio of a time measured by the second clock to a time measured by the virtual timer over the predetermined time interval.

19. The device claim 14, wherein zero, one, or more than one inactive state of the wireless communication device exists during the predetermined time interval.

20. The device claim 14, wherein the predetermined time interval is set dynamically.

21. The device of claim 13, wherein the correction measure is a frequency relation between the first clock and the second clock, and the timing basis is a transmit/receive phase locked loop (PLL) for generating clock signals.

22. The device of claim 21, wherein the frequency relation is measured after waking up from the inactive state or powering up the wireless communication device, and the PLL is controlled based on the frequency relation.

23. The device of claim 21, wherein the calibration unit is configured to adjust the PLL based on a network reference signal.

24. The device of claim 21, wherein the first clock is not temperature compensated and the second clock is temperature compensated.
